(19) United States
(12) Patent Application Publication
(10) Pub. No.: US 2026/0038241 A1
(43) Pub. Date: Feb. 5, 2026

(54) INFORMATION PROCESSING METHOD, INFORMATION PROCESSING SYSTEM, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventors: Jumpei GOTO, Osaka (JP); Kiyofumi ABE, Osaka (JP); Yohei NAKATA, Osaka (JP)

(21) Appl. No.: 19/352,712

(22) Filed: Oct. 8, 2025

Related U.S. Application Data
(63) Continuation of application No. PCT/JP2024/012510, filed on Mar. 27, 2024.

(30) Foreign Application Priority Data
Apr. 13, 2023 (JP) 2023-065485

(51) Int. Cl. G06V 10/764; G06T 7/12

(52) U.S. Cl. CPC G06V 10/764; G06T 7/12; G06V 2201/07

(57) ABSTRACT

An evaluation device acquires an inference result of an evaluation target image by an image recognition model generated by machine learning and uncertainty information indicating instability degree of the inference result, generates inference index information in which a confidence level indicating reliability of the inference result is assigned to information indicating whether the inference result is correct or incorrect by using a correct answer label, the inference result, and the uncertainty information associated with the evaluation target image, and evaluates inference accuracy of the image recognition model based on the inference index information.

### FIELD OF INVENTION

The present disclosure relates to a technique for evaluating inference accuracy of an image recognition model.

### BACKGROUND ART

As image recognition techniques using machine learning, classification, object detection, semantic segmentation, and the like are known. In the classification, a category to which an input image belongs is learned. In the object detection, a category to which coordinates of an object in an input image belong is learned. In semantic segmentation, a category to which each pixel of an input image belongs is learned.

In image recognition using machine learning, a trained machine learning model trained in advance using a large amount of training data is used. Since the trained machine learning model is optimized for an environment acquired by training data, inference cannot be correctly performed for a change in environment or an unseen environment. In this case, it is necessary to perform retraining or additional training of a machine learning model using newly prepared training data. At that time, in order to determine an effect of the additional training, a test data set is prepared, and inference accuracy of the machine learning model before the additional training is compared with inference accuracy of the machine learning model after the additional training with respect to the data set.

For evaluation of inference accuracy of a machine learning model before and after additional training, various indices are used according to a type of an image recognition technique. For example, in Non-Patent Literature 1, an evaluation index such as mean Intersection over Union (mIoU) or mean Pixel Accuracy (mPA) is used in accuracy comparison of semantic segmentation models.

However, in the above-described conventional technique, it is difficult to accurately evaluate inference accuracy of a machine learning model, and further improvement has been required.

Non-Patent Literature 1: Umberto Michieli, Pietro Zanuttigh, “Knowledge Distillation for Incremental Learning in Semantic Segmentation”, Computer Vision and Image Understanding vol. 205, 2021

### SUMMARY OF THE INVENTION

The present disclosure has been made to solve the above problem, and an object of the present disclosure is to provide a technique capable of more accurately evaluating inference accuracy of an image recognition model.

An information processing method according to the present disclosure is an information processing method executed by a computer, the information processing method including acquiring an inference result of an evaluation target image by an image recognition model generated by machine learning and uncertainty information indicating instability degree of the inference result, generating, by using a correct answer label associated with the evaluation target image, the inference result, and the uncertainty information, inference index information to which a confidence level indicating reliability of the inference result is assigned to information indicating whether the inference result is correct or incorrect, and evaluating inference accuracy of the image recognition model based on the inference index information.

Each of these general or specific aspects may be achieved by means of a system, a method, an integrated circuit, a computer program, or a computer-readable recording medium such as a CD-ROM, or may be achieved by an arbitrary combination of the system, the method, the integrated circuit, the computer program, and the recording medium.

According to the present disclosure, inference accuracy of an image recognition model can be more accurately evaluated.

### BRIEF DESCRIPTION OF THE DRAWINGS

FIG. 1 is a diagram illustrating a configuration example of an information processing system according to the present embodiment.

FIG. 2 is a diagram for explaining uncertainty information of inference results calculated in a first image recognition device and a second image recognition device.

FIG. 3 is a flowchart illustrating an example of processing of the first image recognition device according to the present embodiment.

FIG. 4 is a diagram illustrating an example of an evaluation target image, an inference result, and an image obtained by visualizing uncertainty information in the present embodiment.

FIG. 5 is a flowchart illustrating an example of processing of an evaluation device in the present embodiment.

FIG. 6 is a diagram illustrating an example of a correct answer label, an inference result to which a confidence level is assigned, and first inference index information in the present embodiment.

FIG. 7 is a diagram illustrating an example of the first inference index information generated based on an inference result and uncertainty information from the first image recognition device and second inference index information generated based on an inference result and uncertainty information from the second image recognition device in the present embodiment.

FIG. 8 is a diagram illustrating an example of a result of aggregating the number of pixels where a label is changed between the first inference index information and the second inference index information in the present embodiment.

FIG. 9 is a diagram illustrating an example of a result of aggregating the number of pixels where a label is changed between the first inference index information and the second inference index information with respect to a plurality of evaluation target images in the present embodiment.

FIG. 10 is a diagram illustrating an example of labels of the first inference index information and the second inference index information associated with correctness or incorrectness and strictness of evaluation in a case where classes to be evaluated are all classes in the present embodiment.

FIG. 11 is a diagram illustrating an example of labels of the first inference index information and the second inference index information associated with correctness or incorrectness and strictness of evaluation in a case where a class to be evaluated is a person in the present embodiment.

FIG. 12 is a diagram illustrating an example of a result of aggregating the number of pixels of each label included in the first inference index information with respect to a plurality of evaluation target images in a second variation of the present embodiment.

### DETAILED DESCRIPTION

### (Findings as Basis of Present Disclosure)

A conventional evaluation index such as mIoU or mPA does not reflect confidence of inference. For this reason, in a conventional technique, an inference result of which a machine learning model is accidentally correct and an inference result of which the machine learning model is confident and correct are treated equally, and it is difficult to accurately evaluate inference accuracy of the machine learning model.

To solve the above problem, a technique below is disclosed.

(1) An information processing method according to an aspect of the present disclosure is an information processing method executed by a computer, the information processing method including acquiring an inference result of an evaluation target image by an image recognition model generated by machine learning and uncertainty information indicating instability degree of the inference result, generating, by using a correct answer label associated with the evaluation target image, the inference result, and the uncertainty information, inference index information to which a confidence level indicating reliability of the inference result is assigned to information indicating whether the inference result is correct or incorrect, and evaluating inference accuracy of the image recognition model based on the inference index information.

According to this configuration, since inference accuracy of the image recognition model is evaluated in consideration of a confidence level indicating how reliable an inference result is, it is possible to distinguish and evaluate an inference result that is accidentally correct and an inference result that is correct with high confidence, and it is possible to more accurately evaluate inference accuracy of the image recognition model.

(2) In the information processing method according to (1) above, the evaluation of the inference accuracy may include aggregating a plurality of pieces of inference index information acquired from a plurality of evaluation target images, and evaluating the inference accuracy of the image recognition model based on a result of the aggregation.

According to this configuration, the number of pieces of inference index information used for evaluation can be increased, and inference accuracy of the image recognition model can be more accurately evaluated.

(3) In the information processing method according to (1) and (2) above, the generation of the inference index information may include generating the inference index information in which the correct answer label, a class recognized as the inference result by the image recognition model, and the confidence level of N stages are associated with an inference unit of the image recognition model.

According to this configuration, the correct answer label, the class recognized as an inference result by the image recognition model, and the confidence level of N stages can be associated with an inference unit of the image recognition model.

(4) In the information processing method according to (3) above, the confidence level of N stages may include a first confidence level and a second confidence level lower than the first confidence level. According to this configuration, since the confidence level of N stages includes the first confidence level and the second confidence level lower than the first confidence level, the confidence level can be expressed in two stages.

(5) In the information processing method according to (3) above, the image recognition model may include a first image recognition model and a second image recognition model, and the evaluation of the inference accuracy may include comparing the inference accuracy of the first image recognition model with the inference accuracy of the second image recognition model according to a change from first inference index information generated based on the first image recognition model to second inference index information generated based on the second image recognition model.

According to this configuration, it is possible to compare inference accuracy of the first image recognition model with inference accuracy of the second image recognition model, and it is possible to evaluate which of the inference accuracy of the first image recognition model and the inference accuracy of the second image recognition model is higher.

(6) In the information processing method according to (5) above, the evaluation of the inference accuracy may include counting the number of the inference units that change from the first inference index information in which the inference result is correct to the second inference index information in which the inference result is incorrect, and calculating deterioration degree indicating how much the inference accuracy of the second image recognition model is deteriorated with respect to the inference accuracy of the first image recognition model according to the counted number.

According to this configuration, it is possible to evaluate deterioration degree indicating how much inference accuracy of the second image recognition model is deteriorated with respect to inference accuracy of the first image recognition model.

(7) In the information processing method according to (5) above, the evaluation of the inference accuracy may include counting the number of the inference units that change from the first inference index information in which the confidence level is a first confidence level and the inference result is correct to the second inference index information in which the confidence level is a second confidence level lower than the first confidence level and the inference result is correct, and calculating the deterioration degree according to the counted number, or counting the number of the inference units that change from the first inference index information in which the confidence level is the second confidence level and the inference result is incorrect to the second inference index information in which the confidence level is the first confidence level and the inference result is incorrect, and calculating the deterioration degree according to the counted number.

According to this configuration, deterioration degree indicating how much inference accuracy of the second image recognition model is deteriorated with respect to inference accuracy of the first image recognition model can be evaluated in consideration of the confidence level indicating how reliable an inference result is.

(8) In the information processing method according to (5) above, the evaluation of the inference accuracy may include counting the number of the inference units that change from the first inference index information in which the inference result is incorrect to the second inference index information in which the inference result is correct, and calculating improvement degree indicating how much the inference accuracy of the second image recognition model is improved with respect to the inference accuracy of the first image recognition model according to the counted number.

According to this configuration, it is possible to evaluate improvement degree indicating how much inference accuracy of the second image recognition model is improved with respect to inference accuracy of the first image recognition model.

(9) In the information processing method according to (5) above, the evaluation of the inference accuracy may include counting the number of the inference units that change from the first inference index information in which the confidence level is a second confidence level lower than a first confidence level and the inference result is correct to the second inference index information in which the confidence level is the first confidence level and the inference result is correct, and calculating the improvement degree according to the counted number, or counting the number of the inference units that change from the first inference index information in which the confidence level is the first confidence level and the inference result is incorrect to the second inference index information in which the confidence level is the second confidence level and the inference result is incorrect, and calculating the improvement degree according to the counted number.

According to this configuration, improvement degree indicating how much inference accuracy of the second image recognition model is improved with respect to inference accuracy of the first image recognition model can be evaluated in consideration of the confidence level indicating how reliable an inference result is.

(10) The information processing method according to (5) above may further include receiving a change of a combination of the first inference index information generated based on the first image recognition model and a combination of the second inference index information generated based on the second image recognition model.

According to this configuration, strictness of evaluation of inference accuracy of the first image recognition model and inference accuracy of the second image recognition model can be changed by changing a combination of the first inference index information and a combination of the second inference index information.

(11) In the information processing method according to any one of (1) to (10) above, an inference unit of the image recognition model may be each pixel constituting the evaluation target image. According to this configuration, the image recognition model can perform inference for each pixel constituting an evaluation target image.

(12) In the information processing method according to (11) above, the image recognition model may perform semantic segmentation for classifying each of a plurality of pixels constituting the evaluation target image into one or more classes. According to this configuration, the image recognition model can perform semantic segmentation for classifying each of a plurality of pixels constituting an evaluation target image into one or more classes.

(13) In the information processing method according to any one of (1) to (10) above, an inference unit of the image recognition model may be each of the evaluation target images. According to this configuration, the image recognition model can perform inference for each evaluation target image.

(14) In the information processing method according to (13) above, the image recognition model may classify the evaluation target image into one or more classes. According to this configuration, the image recognition model can classify an evaluation target image into one or more classes.

(15) In the information processing method according to any one of (1) to (10) above, an inference unit of the image recognition model may be each bounding box in the evaluation target images. According to this configuration, the image recognition model can perform inference for each bounding box in an evaluation target image.

(16) In the information processing method according to (15) above, the image recognition model may detect a specific object included in the evaluation target image. According to this configuration, the image recognition model can detect a specific object included in an evaluation target image.

The present disclosure can be realized not only as an information processing method for executing characteristic processing as described above, but also as an information processing system or the like including a characteristic configuration corresponding to characteristic processing executed by the information processing method. Further, the present disclosure can also be realized as a computer program that causes a computer to execute characteristic processing included in the information processing method described above. Therefore, even in another aspect below, an effect as in the above information processing method can be achieved.

(17) An information processing system according to another aspect of the present disclosure includes an acquisition part that acquires an inference result of an evaluation target image by an image recognition model generated by machine learning and uncertainty information indicating instability degree of the inference result, a generation part that generates, by using a correct answer label associated with the evaluation target image, the inference result, and the uncertainty information, inference index information to which a confidence level indicating reliability of the inference result is assigned to information indicating whether the inference result is correct or incorrect, and an evaluation part that evaluates inference accuracy of the image recognition model based on the inference index information.

(18) An information processing program according to another aspect of the present disclosure causes a computer to function to acquire an inference result of an evaluation target image by an image recognition model generated by machine learning and uncertainty information indicating instability degree of the inference result, generate, by using a correct answer label associated with the evaluation target image, the inference result, and the uncertainty information, inference index information to which a confidence level indicating reliability of the inference result is assigned to information indicating whether the inference result is correct or incorrect, and evaluate inference accuracy of the image recognition model based on the inference index information.

(19) A non-transitory computer-readable recording medium according to another aspect of the present disclosure records the information processing program according to (18) above.

Hereinafter, an embodiment according to the present disclosure will be described with reference to the drawings.

Note that each of embodiments to be described below illustrates a specific example of the present disclosure. A numerical value, a shape, a material, a constituent element, an arranged position and a connection mode of a constituent element, a step, order of steps, and the like shown in an embodiment below are merely examples, and are not intended to limit the present disclosure. Further, a constituent element not described in an independent claim representing a highest concept among constituent elements in the embodiments below is described as an optional constituent element. Further, in all the embodiments, content of each of the embodiments can be combined.

### EMBODIMENT

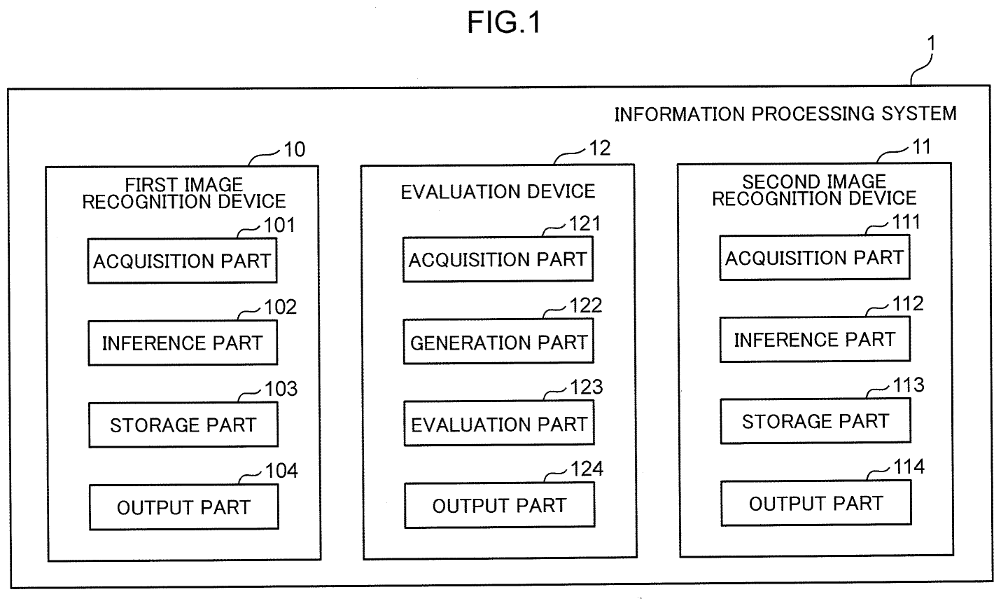

FIG. 1 is a diagram illustrating a configuration example of an information processing system according to the present embodiment.

An information processing system 1 is a system that compares and evaluates inference accuracy of image recognition by a first image recognition device 10 and inference accuracy of image recognition by a second image recognition device 11. The information processing system 1 includes the first image recognition device 10 to be evaluated, the second image recognition device 11 to be evaluated, and an evaluation device 12 that compares and evaluates the first image recognition device 10 and the second image recognition device 11. In the information processing system 1, the first image recognition device 10 and the evaluation device 12 are connected so as to be able to communicate data bidirectionally, and the second image recognition device 11 and the evaluation device 12 are connected so as to be able to communicate data bidirectionally.

The first image recognition device 10, the second image recognition device 11, and the evaluation device 12 include at least a computer system including, for example, a control program, a processing circuit such as a processor or a logic circuit that executes the control program, and a recording device such as an internal memory or an accessible external memory that stores the control program. Note that the first image recognition device 10, the second image recognition device 11, and the evaluation device 12 may be realized by, for example, hardware implementation by a processing circuit, execution, by the processing circuit, of a software program held in a memory or distributed from an external server, or a combination of the hardware implementation and the software implementation.

The first image recognition device 10 includes an acquisition part 101, an inference part 102, a storage part 103, and an output part 104.

The acquisition part 101 acquires an evaluation target image for evaluating inference accuracy of a first image recognition model used by the first image recognition device 10. The evaluation target image may be stored in advance in the storage part 103, and the acquisition part 101 may read the evaluation target image from the storage part 103. Further, the acquisition part 101 may acquire the evaluation target image from an external device via a communication part (not illustrated).

The storage part 103 stores a trained first image recognition model (machine learning model). The storage part 103 stores the first image recognition model generated by machine learning. The machine learning is, for example, deep learning.

The inference part 102 reads the trained first image recognition model stored in the storage part 103, applies the first image recognition model to an evaluation target image acquired by the acquisition part 101 to perform inference, and acquires an inference result. The inference part 102 inputs the evaluation target image to the first image recognition model and acquires an inference result output from the first image recognition model.

An inference unit of the first image recognition model may be for each evaluation target image. In this case, the first image recognition model may classify an evaluation target image into one or more classes (classification). Further, an inference unit of the first image recognition model may be for each bounding box in an evaluation target image. In this case, the first image recognition model may detect a specific object included in an evaluation target image (object detection). The bounding box is a rectangular region indicating a position and size of a specific object included in an evaluation target image. Further, an inference unit of the first image recognition model may be for each of a plurality of pixels constituting an evaluation target image. In this case, the first image recognition model may classify each of a plurality of pixels constituting an evaluation target image into one or more classes (semantic segmentation). An inference result may be a result obtained by classifying an evaluation target image into one or more classes, may be a value of a position or size of a specific target included in an evaluation target image, or may be a result obtained by classifying an evaluation target image for each pixel.

Further, the inference part 102 calculates uncertainty information indicating the instability degree of an inference result. Note that the uncertainty information will be described later.

The output part 104 outputs an inference result and uncertainty information calculated by the inference part 102 to the evaluation device 12.

The second image recognition device 11 includes an acquisition part 111, an inference part 112, a storage part 113, and an output part 114. The second image recognition device 11 has the same configuration as the first image recognition device 10.

Note that the acquisition part 111 acquires the same evaluation target image as the evaluation target image acquired by the acquisition part 101. Further, the storage part 113 stores a second image recognition model different from the first image recognition model stored in the storage part 103. For example, the second image recognition model used in the second image recognition device 11 may be a model obtained by additionally training the first image recognition model used in the first image recognition device 10. Further, for example, the first image recognition model used in the first image recognition device 10 and the second image recognition model used in the second image recognition device 11 may be models trained using different data sets. An architecture of the first image recognition model and an architecture of the second image recognition model may be different from each other. A format of first image recognition model output and a format of second image recognition model output are the same. For example, a format of output in semantic segmentation represents the number of pixels of an inference result or the number of inference classes. Further, training processing of the second image recognition model and training processing of the first image recognition model may be different.

The inference part 112 reads the trained second image recognition model stored in the storage part 113, applies the second image recognition model to an evaluation target image acquired by the acquisition part 111 to perform inference, and acquires an inference result. The inference part 112 inputs the evaluation target image to the second image recognition model and acquires an inference result output from the second image recognition model.

The evaluation device 12 includes an acquisition part 121, a generation part 122, an evaluation part 123, and an output part 124.

The acquisition part 121 receives a correct answer label and also receives output from the first image recognition device 10 and the second image recognition device 11.

The acquisition part 121 acquires, from the first image recognition device 10, an inference result of an evaluation target image by the first image recognition model generated by machine learning, and uncertainty information indicating instability degree of the inference result. Further, the acquisition part 121 acquires, from the second image recognition device 11, an inference result of an evaluation target image by the second image recognition model generated by machine learning, and uncertainty information indicating instability degree of the inference result. Further, the acquisition part 121 acquires a correct answer label associated with an evaluation target image used for inference of the first image recognition model and the second image recognition model. The acquisition part 121 may read a correct answer label from a storage part (not illustrated). Further, the acquisition part 101 may acquire a correct answer label from an external device via a communication part (not illustrated).

The generation part 122 uses a correct answer label associated with an evaluation target image, an inference result acquired from the first image recognition device 10, and uncertainty information acquired from the first image recognition device 10 to generate first inference index information in which a confidence level indicating reliability of an inference result of the first image recognition model is assigned to information indicating whether the inference result is correct or incorrect. Further, the generation part 122 uses a correct answer label associated with an evaluation target image, an inference result acquired from the second image recognition device 11, and uncertainty information acquired from the second image recognition device 11 to generate second inference index information in which a confidence level indicating reliability of an inference result of the second image recognition model is assigned to information indicating whether the inference result is correct or incorrect.

The generation part 122 generates the first inference index information in which a correct answer label, a class recognized as an inference result by the first image recognition model, and confidence levels of N stages are associated with an inference unit of the first image recognition model. Further, the generation part 122 generates the second inference index information in which a correct answer label, a class recognized as an inference result by the second image recognition model, and confidence levels of N stages are associated with an inference unit of the second image recognition model. Confidence levels of N stages include a first confidence level and a second confidence level lower than the first confidence level.

The evaluation part 123 compares inference accuracy by the first image recognition device 10 with inference accuracy by the second image recognition device 11 from a correct answer label, an inference result and uncertainty information by the first image recognition device 10, and an inference result and uncertainty information by the second image recognition device 11.

The evaluation part 123 compares inference accuracy of the first image recognition model with inference accuracy of the second image recognition model based on the first inference index information and the second inference index information. The evaluation part 123 compares inference accuracy of the first image recognition model with inference accuracy of the second image recognition model according to a change from the first inference index information generated based on the first image recognition model to the second inference index information generated based on the second image recognition model.

The evaluation part 123 counts the number of inference units changed from the first inference index information in which an inference result is correct to the second inference index information in which an inference result is incorrect, and calculates deterioration degree indicating how much inference accuracy of the second image recognition model is deteriorated with respect to inference accuracy of the first image recognition model according to the counted number. More specifically, the evaluation part 123 counts the number of inference units changed from the first inference index information in which a confidence level is the first confidence level and an inference result is correct to the second inference index information in which a confidence level is the first confidence level and an inference result is incorrect or the second inference index information in which a confidence level is the second confidence level lower than the first confidence level and an inference result is incorrect, and calculates deterioration degree indicating how much inference accuracy of the second image recognition model is deteriorated with respect to inference accuracy of the first image recognition model according to the counted number.

Further, the evaluation part 123 may count the number of inference units changed from the first inference index information in which a confidence level is the first confidence level and an inference result is correct to the second inference index information in which a confidence level is the second confidence level lower than the first confidence level and an inference result is correct, and calculate deterioration degree according to the counted number. Further, the evaluation part 123 may count the number of inference units changed from the first inference index information in which a confidence level is the second confidence level and an inference result is incorrect to the second inference index information in which a confidence level is the first confidence level and an inference result is incorrect, and calculate deterioration degree according to the counted number.

Further, the evaluation part 123 counts the number of inference units changed from the first inference index information in which an inference result is incorrect to the second inference index information in which an inference result is correct, and calculates improvement degree indicating how much inference accuracy of the second image recognition model is improved with respect to inference accuracy of the first image recognition model according to the counted number. More specifically, the evaluation part 123 counts the number of inference units changed from the first inference index information in which a confidence level is the first confidence level and an inference result is incorrect or the first inference index information in which a confidence level is the second confidence level lower than the first confidence level and an inference result is incorrect to the second inference index information in which a confidence level is the first confidence level and an inference result is correct, and calculates improvement degree indicating how much inference accuracy of the second image recognition model is improved with respect to inference accuracy of the first image recognition model according to the counted number.

Further, the evaluation part 123 may count the number of inference units changed from the first inference index information in which a confidence level is the second confidence level lower than the first confidence level and an inference result is correct to the second inference index information in which a confidence level is the first confidence level and an inference result is correct, and calculate improvement degree according to the counted number. Further, the evaluation part 123 may count the number of inference units changed from the first inference index information in which a confidence level is the first confidence level and an inference result is incorrect to the second inference index information in which a confidence level is the second confidence level and an inference result is incorrect, and calculate improvement degree according to the counted number.

The evaluation part 123 aggregates a plurality of pieces of the first inference index information acquired from a plurality of evaluation target images. Further, the evaluation part 123 aggregates a plurality of pieces of the second inference index information acquired from a plurality of evaluation target images. The evaluation part 123 evaluates inference accuracy of the first image recognition model and inference accuracy of the second image recognition model based on an aggregation result.

The output part 124 outputs a comparison result of inference accuracy by the evaluation part 123. The output part 124 may output at least one of deterioration degree and improvement degree calculated by the evaluation part 123 as an evaluation result.

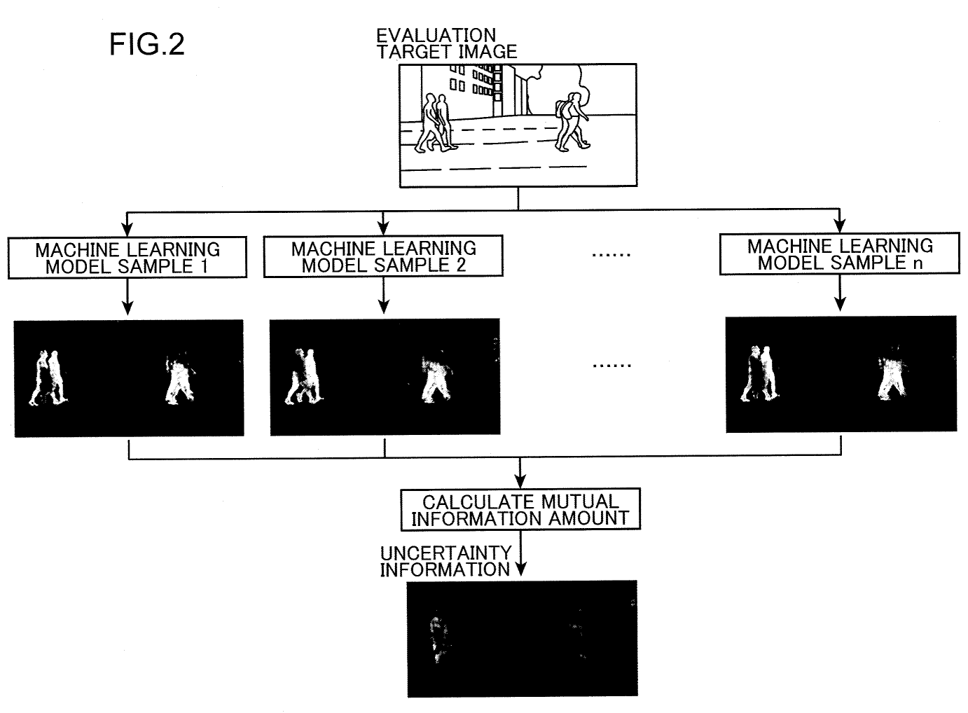

FIG. 2 is a diagram for explaining uncertainty information of an inference result calculated in the first image recognition device 10 and the second image recognition device 11.

Uncertainty information of an inference result is introduced as an index for measuring stability of an inference of a machine learning model (image recognition model). For example, in FIG. 2, the inference part 102 samples a plurality of parameters of a machine learning model by a method called Monte Carlo dropout, and acquires a plurality of inference results by using each of a plurality of parameters. Then, the inference part 102 calculates a mutual information amount of a plurality of inference results as uncertainty information of the inference result. The mutual information amount indicates degree of variation among mutual inference results.

Note that a method of calculating uncertainty information of an inference result is not limited to a method using Monte Carlo dropout. For example, the first image recognition model may output both an inference result and uncertainty information. The inference part 102 may input an evaluation target image to the first image recognition model and acquire an inference result and uncertainty information output from the first image recognition model. Further, the inference part 102 may sample a plurality of parameters of the first image recognition model, acquire a plurality of inference results using each of a plurality of parameters, and calculate a variance of a plurality of inference results as uncertainty information. Further, the inference part 102 may acquire a plurality of inference results by using a plurality of the first image recognition models, and calculate a mutual information amount or a variance of a plurality of inference results as uncertainty information. Furthermore, the inference part 102 may create a plurality of evaluation target images by performing a plurality of types of data processing on an evaluation target image. The inference part 102 may input each of a plurality of evaluation target images to the first image recognition model and acquire a plurality of inference results output from the first image recognition model. The inference part 102 may calculate a mutual information amount or a variance of a plurality of inference results as uncertainty information. A method of calculating these pieces of uncertainty information is disclosed in a reference below.

### REFERENCE

Jakob Gawlikowski, et al., “A Survey of Uncertainty in Deep Neural Networks” arXiv preprint arXiv: 2107.03342, 2021.

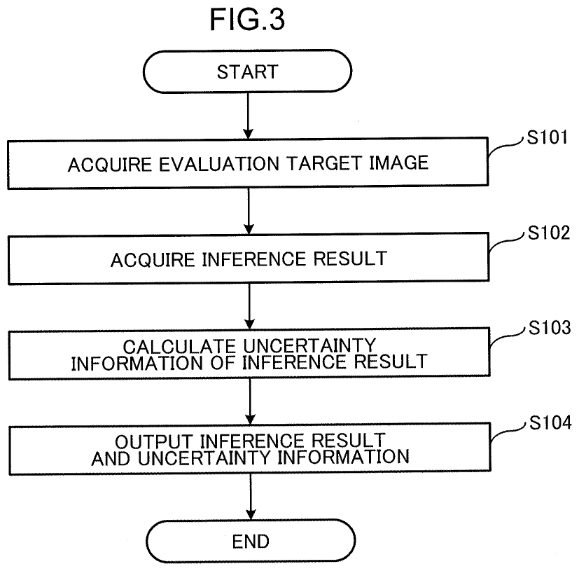

Next, a flow of processing of calculating an inference result and uncertainty information of the inference result in the first image recognition device 10 and the second image recognition device 11 will be described with reference to FIG. 3.

FIG. 3 is a flowchart illustrating an example of processing of the first image recognition device 10 according to the present embodiment. Note that processing of the second image recognition device 11 is the same as the processing of the first image recognition device 10.

First, in Step S101, the acquisition part 101 of the first image recognition device 10 acquires an evaluation target image. Further, the acquisition part 111 of the second image recognition device 11 acquires an evaluation target image. The evaluation target image is an image in a test data set prepared in advance. The acquisition part 101 may acquire one evaluation target image or may acquire a plurality of evaluation target images.

Next, in Step S102, the inference part 102 of the first image recognition device 10 reads the trained first image recognition model stored in the storage part 103, applies the first image recognition model to the evaluation target image to perform inference, and acquires an inference result from the first image recognition model. Further, the inference part 112 of the second image recognition device 11 reads the trained second image recognition model stored in the storage part 113, applies the second image recognition model to the evaluation target image to perform inference, and acquires an inference result from the second image recognition model.

Next, in Step S103, the inference part 102 of the first image recognition device 10 calculates uncertainty information indicating instability degree of the inference result. Further, the inference part 112 of the second image recognition device 11 calculates uncertainty information indicating instability degree of the inference result.

Next, in Step S104, the output part 104 of the first image recognition device 10 outputs the inference result acquired by the inference part 102 and the uncertainty information calculated by the inference part 102 to the evaluation device 12. Further, the output part 114 of the second image recognition device 11 outputs the inference result acquired by the inference part 112 and the uncertainty information calculated by the inference part 112 to the evaluation device 12.

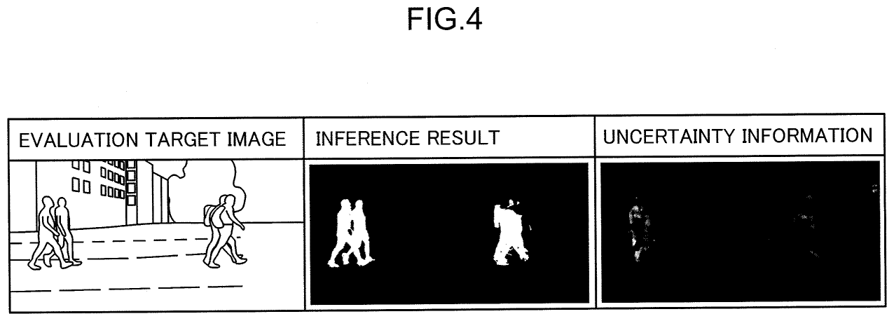

FIG. 4 is a diagram illustrating an example of an evaluation target image, an inference result, and an image obtained by visualizing uncertainty information in the present embodiment.

In FIG. 4, the first image recognition model and the second image recognition model perform semantic segmentation for detecting a pixel representing a person from the evaluation target image. In the inference result, pixels classified as a person are represented in white, and pixels classified as other than a person are represented in black. Further, the image obtained by visualizing uncertainty information shows that a region has higher uncertainty as colors of pixels are whiter. As a value of a mutual information amount, which is uncertainty information, increases, a color of a pixel becomes whiter. That is, a region in which a pixel is white indicates a region in which an estimation result is unstable and classification can be accidentally made or a region in which classification cannot be accidentally made.

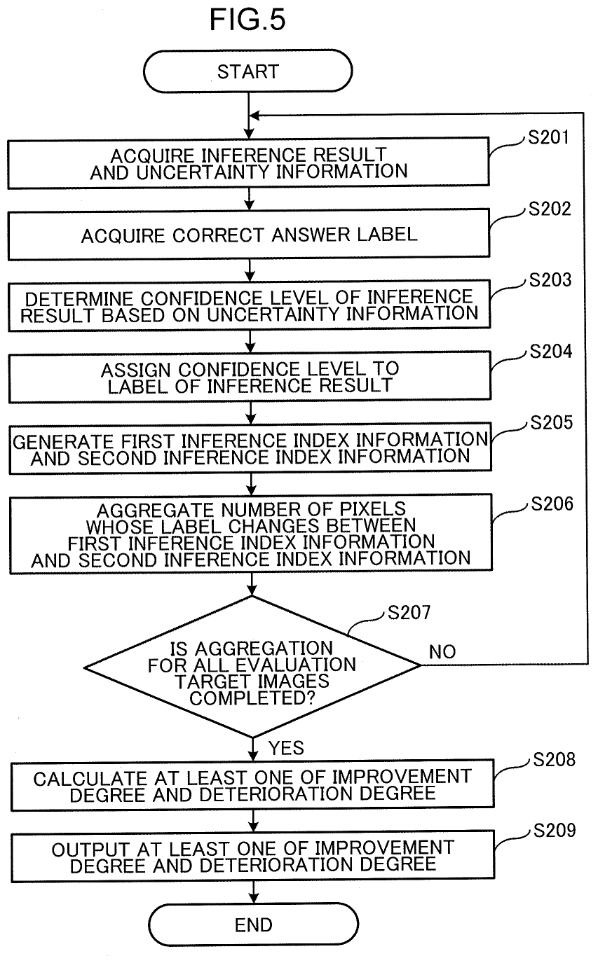

Next, a flow of processing of evaluating inference accuracy of the first image recognition device 10 and the second image recognition device 11 in the evaluation device 12 will be described with reference to FIG. 5.

FIG. 5 is a flowchart illustrating an example of processing of the evaluation device 12 according to the present embodiment.

First, in Step S201, the acquisition part 121 acquires an inference result and uncertainty information output from the first image recognition device 10, and acquires an inference result and uncertainty information output from the second image recognition device 11.

Next, in Step S202, the acquisition part 121 acquires a correct answer label associated with an evaluation target image.

Next, in Step S203, the generation part 122 determines a confidence level indicating how reliable the inference result is based on the uncertainty information acquired by the acquisition part 121. The generation part 122 determines whether or not the uncertainty information calculated by the first image recognition device 10 and the second image recognition device 11 is more than or equal to a preset threshold. Here, the threshold is a value for determining whether the first image recognition device 10 and the second image recognition device 11 have confidence in an inference result. In the present embodiment, the confidence level is expressed in two stages, “high” and “low”. The confidence level “high” corresponds to the first confidence level, and the confidence level “low” corresponds to the second confidence level lower than the first confidence level. In a case where it is determined that uncertainty information is less than the threshold, the generation part 122 determines the confidence level to be “high”. Further, in a case where it is determined that uncertainty information is equal to or more than the threshold, the generation part 122 determines the confidence level to be “low”. The generation part 122 determines a confidence level of an estimation result of the first image recognition model and a confidence level of an estimation result of the second image recognition model.

Note that, by setting N−1 thresholds, a level of uncertainty information calculated by the first image recognition device 10 and the second image recognition device 11 may be divided into N stages and evaluated.

Next, in Step S204, the generation part 122 assigns a confidence level to a label of an inference result from the determined confidence level and the inference result. The generation part 122 assigns a confidence level to the estimation result of the first image recognition model and assigns a confidence level to the estimation result of the second image recognition model.

Next, in Step S205, the generation part 122 generates the first inference index information and the second inference index information. Based on the correct answer label acquired by the acquisition part 121 and the inference result of the first image recognition model to which a confidence level is assigned, the generation part 122 generates the first inference index information in which a confidence level is assigned to information indicating whether the inference result of the first image recognition model is correct or incorrect. Based on the correct answer label acquired by the acquisition part 121 and the inference result of the second image recognition model to which a confidence level is assigned, the generation part 122 generates the second inference index information in which a confidence level is assigned to information indicating whether the inference result of the second image recognition model is correct or incorrect. Here, the first inference index information is obtained by assigning a confidence level to whether the inference result of the first image recognition model is correct or not, and the second inference index information is obtained by assigning a confidence level to whether the inference result of the second image recognition model is correct or not.

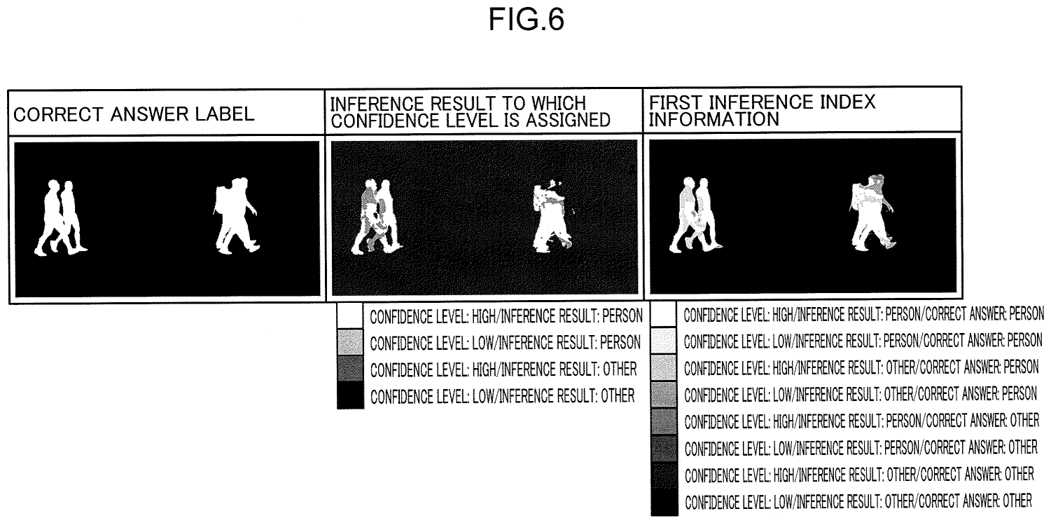

FIG. 6 is a diagram illustrating an example of a correct answer label, an inference result to which a confidence level is assigned, and the first inference index information in the present embodiment.

In FIG. 6, the first image recognition model and the second image recognition model perform semantic segmentation for detecting a pixel representing a person from an evaluation target image. In the correct answer label, pixels representing a person are represented in white, and pixels representing other than a person are represented in black. Further, in an inference result to which a confidence level is assigned, pixels corresponding to four types of labels are represented by shades of color. The four types of labels are “confidence level: high/inference result: person”, “confidence level: low/inference result: person”, “confidence level: high/inference result: other”, and “confidence level: low/inference result: other”. Further, in the first inference index information, pixels corresponding to eight types of labels are represented by shades of color. The eight types of labels are “confidence level: high/inference result: person/correct answer: person”, “confidence level: low/inference result: person/correct answer: person”, “confidence level: high/inference result: other/correct answer: person”, “confidence level: low/inference result: other/correct answer: person”, “confidence level: high/inference result: person/correct answer: other”, “confidence level: low/inference result: person/correct answer: other”, “confidence level: high/inference result: other/correct answer: other”, and “confidence level: low/inference result: other/correct answer: other”.

For example, a region in which the confidence level is “high” and the inference result matches the correct answer label indicates a region in which inference is successful with high accuracy. In contrast, a region in which the confidence level is “high” and the inference result and the correct answer label do not match indicates a region in which inference fails with high accuracy.

Next, in Step S206, the evaluation part 123 aggregates the number of pixels whose label changes between the first inference index information and the second inference index information.

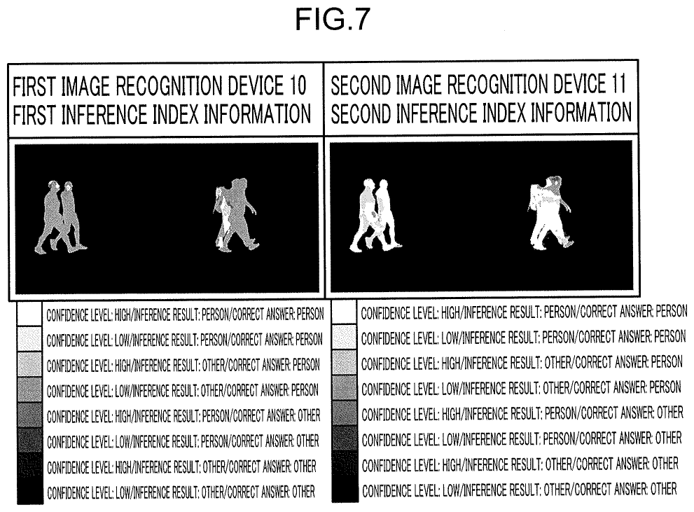

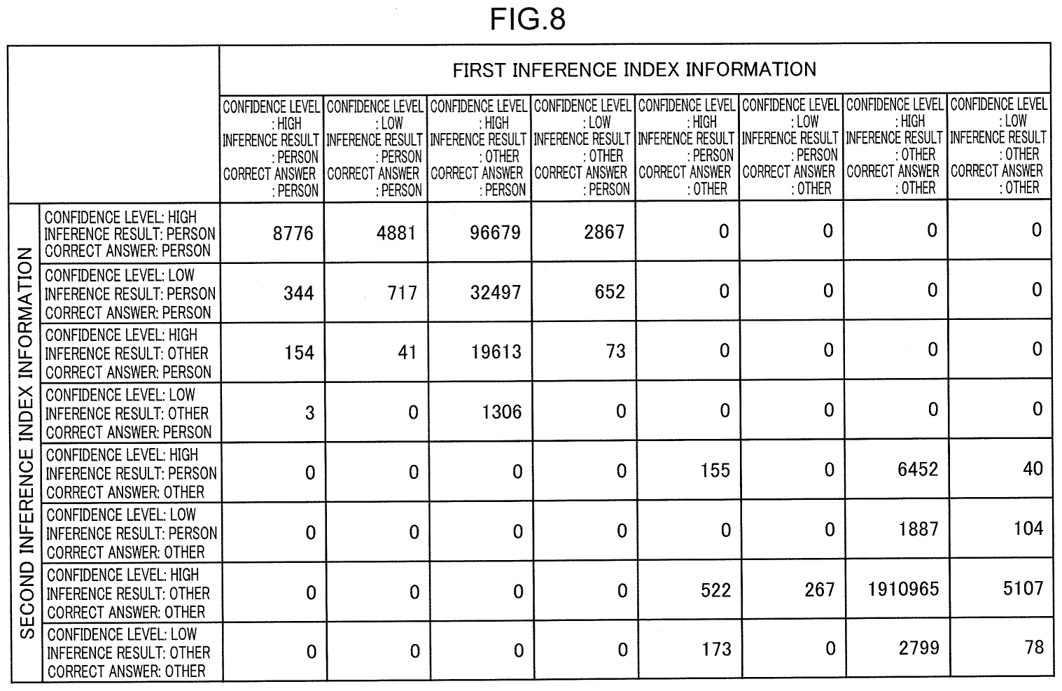

FIG. 7 is a diagram illustrating an example of the first inference index information generated based on an inference result and uncertainty information from the first image recognition device 10 and second inference index information generated based on an inference result and uncertainty information from the second image recognition device 11 in the present embodiment. FIG. 8 is a diagram illustrating an example of a result of aggregating the number of pixels where a label is changed between the first inference index information and the second inference index information in the present embodiment.

In FIGS. 7 and 8, the first image recognition model and the second image recognition model perform semantic segmentation for detecting a pixel representing a person from an evaluation target image. In the first inference index information and the second inference index information, pixels corresponding to eight types of labels are represented by shades of color. The eight types of labels are “confidence level: high/inference result: person/correct answer: person”, “confidence level: low/inference result: person/correct answer: person”, “confidence level: high/inference result: other/correct answer: person”, “confidence level: low/inference result: other/correct answer: person”, “confidence level: high/inference result: person/correct answer: other”, “confidence level: low/inference result: person/correct answer: other”, “confidence level: high/inference result: other/correct answer: other”, and “confidence level: low/inference result: other/correct answer: other”.

Further, in a table of FIG. 8, a row of the table represents a label of the first inference index information corresponding to the first image recognition device 10, a column of the table represents a label of the second inference index information corresponding to the second image recognition device 11, and a value of each cell represents the number of pixels changed between corresponding labels.

For example, the number of pixels changed from the label “confidence level: low/inference result: other/correct answer: person” of the first inference index information to the label “confidence level: high/inference result: person/correct answer: person” of the second inference index information is 2867. Further, in a case where the first image recognition device 10 and the second image recognition device 11 use the same evaluation target image, a correct answer label of the first inference index information and a correct answer label of the second inference index information are the same, and there is no change from “correct answer: person” to “correct answer: other”, and there is no change from “correct answer: other” to “correct answer: person”. Therefore, a value of cells corresponding to these is 0.

Next, in Step S207, the evaluation part 123 determines whether or not aggregation for all evaluation target images in a test data set prepared in advance is completed. Here, in a case where it is determined that the aggregation for all evaluation target images is not completed (NO in Step S207), the processing returns to Step S201. The evaluation part 123 applies processing from acquisition of an inference result and uncertainty information to aggregation of the number of pixels whose label changes to one or a plurality of evaluation target images in a test data set prepared in advance. By this, the evaluation part 123 aggregates the number of pixels whose label changes between the first inference index information and the second inference index information for all evaluation target images.

On the other hand, in a case where it is determined that aggregation for all evaluation target images is completed (YES in Step S207), in Step S208, the evaluation part 123 calculates at least one of deterioration degree and improvement degree based on a change in the number of pixels between the aggregated first inference index information and second inference index information.

For example, the evaluation part 123 calculates deterioration degree indicating how much inference accuracy of the second image recognition device 11 is deteriorated with respect to inference accuracy of the first image recognition device 10 based on a ratio of pixels that change from a correct answer label with a high confidence level to an incorrect answer label. Further, for example, the evaluation part 123 calculates improvement degree indicating how much inference accuracy of the second image recognition device 11 is improved with respect to inference accuracy of the first image recognition device 10 from a ratio of pixels that change from an incorrect answer label to a correct answer label with a high confidence level. Note that the evaluation part 123 may calculate either the improvement degree or the deterioration degree, or may calculate both the improvement degree and the deterioration degree.

Further, the evaluation part 123 may evaluate which of inference accuracy of the first image recognition device 10 and inference accuracy of the second image recognition device 11 is better by comparing deterioration degree and improvement degree. For example, in a case where improvement degree is higher than deterioration degree, the evaluation part 123 may evaluate that inference accuracy of the second image recognition device 11 is better than inference accuracy of the first image recognition device 10. Further, in a case where improvement degree is lower than deterioration degree, the evaluation part 123 may evaluate that inference accuracy of the second image recognition device 11 is worse than inference accuracy of the first image recognition device 10.

Next, in Step S209, the output part 124 outputs at least one of the deterioration degree and the improvement degree calculated by the evaluation part 123 as an evaluation result. For example, the output part 124 may output an evaluation result to a display device. The display device is, for example, a liquid crystal display, and is connected to the evaluation device 12 so as to be able to communicate with each other in a wireless or wired manner. The display device may display an evaluation result. By this, a result of comparison between the first image recognition model and the second image recognition model can be presented to the user.

Note that the output part 124 may output an evaluation result indicating whether or not inference accuracy of the second image recognition device 11 is better than inference accuracy of the first image recognition device 10.

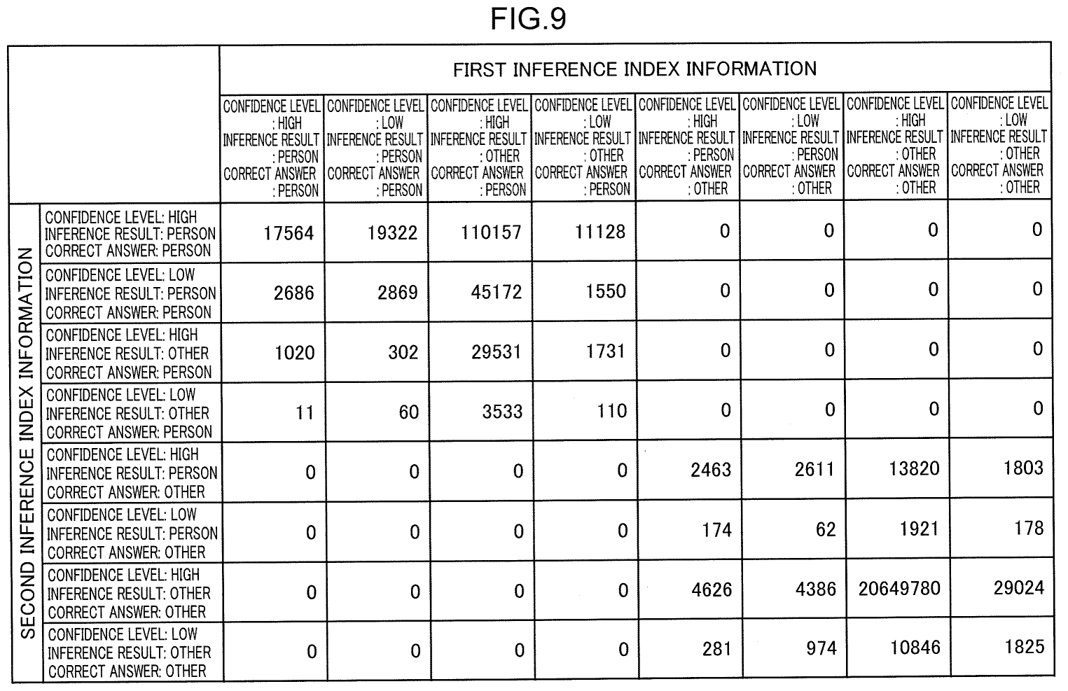

FIG. 9 is a diagram illustrating an example of a result of aggregating the number of pixels where a label is changed between the first inference index information and the second inference index information with respect to a plurality of evaluation target images in the present embodiment.

In FIG. 9, the first image recognition model and the second image recognition model perform semantic segmentation for detecting a pixel representing a person from an evaluation target image. Further, the example of FIG. 9 represents an aggregation result using the first inference index information and the second inference index information generated from ten evaluation target images.

In the example of FIG. 9, the total number of pixels of a plurality of evaluation target images in a test data set is, from the product of the number of (ten) evaluation target images and an image resolution (2048*1024), 10*2048*1024=20971520.

The evaluation part 123 adds the number of pixels that change from the label “confidence level: high/inference result: person/correct answer: person” of the first inference index information to the labels “confidence level: high/inference result: other/correct answer: person” and “confidence level: low/inference result: other/correct answer: person” of the second inference index information and the number of pixels that change from the label “confidence level: high/inference result: other/correct answer: other” of the first inference index information to the labels “confidence level: high/inference result: person/correct answer: other” and “confidence level: low/inference result: person/correct answer: other” of the second inference index information and divides the added value by the total number of pixels to calculate the deterioration degree. In this case, the deterioration degree is calculated as (1020+11+13820+1921)/20971520*100=0.079975(%).

Further, the evaluation part 123 adds the number of pixels that change from the label “confidence level: high/inference result: other/correct answer: person” of the first inference index information to the label “confidence level: high/inference result: person/correct answer: person” of the second inference index information, the number of pixels that change from the label “confidence level: low/inference result: other/correct answer: person” of the first inference index information to the label “confidence level: high/inference result: person/correct answer: person” of the second inference index information, the number of pixels that change from the label “confidence level: high/inference result: person/correct answer: other” of the first inference index information to the label “confidence level: high/inference result: other/correct answer: other” of the second inference index information, and the number of pixels that change from the label “confidence level: low/inference result: person/correct answer: other” of the first inference index information to the label “confidence level: high/inference result: other/correct answer: other” of the second inference index information, and divides the added value by the total number of pixels to calculate the improvement degree. In this case, the improvement degree is calculated as (110157+11128+4626+4386)/20971520*100=0.621305(%).

A relationship between the deterioration degree and the improvement degree is 0.079975<0.621305, and the improvement degree is larger than the deterioration degree. In this case, the evaluation part 123 can evaluate that the inference accuracy of the second image recognition device 11 is better than the inference accuracy of the first image recognition device 10. On the other hand, in a case where the improvement degree is smaller than the deterioration degree, the evaluation part 123 may evaluate that the inference accuracy of the second image recognition device 11 is worse than the inference accuracy of the first image recognition device 10.

Note that an index used for calculating deterioration degree and improvement degree is not limited to the above, and deterioration degree and improvement degree may be calculated using other indices. For example, the evaluation part 123 may add the number of pixels that change from the label “confidence level: high/inference result: person/correct answer: person” of the first inference index information to the labels “confidence level: high/inference result: other/correct answer: person”, “confidence level: low/inference result: other/correct answer: person”, and “confidence level: low/inference result: person/correct answer: person” of the second inference index information and the number of pixels that change from the label “confidence level: high/inference result: other/correct answer: other” of the first inference index information to the labels “confidence level: high/inference result: person/correct answer: other”, “confidence level: low/inference result: person/correct answer: other”, and “confidence level: low/inference result: other/correct answer: other” of the second inference index information, and divides the added value by the total number of pixels to calculate the deterioration degree. In this case, the deterioration degree is calculated as (1020+11+2686+13820+1921+10846)/20971520*100=0.144501(%). In this case, the deterioration degree is larger than the deterioration degree 0.079975 described above, and the deterioration degree is more strictly evaluated.

As described above, since inference accuracy of the first image recognition model and inference accuracy of the second image recognition model are evaluated in consideration of a confidence level indicating how reliable an inference result is, it is possible to distinguish and evaluate an inference result that is accidentally correct and an inference result that is correct with high confidence, and it is possible to more accurately evaluate inference accuracy of the first image recognition model and inference accuracy of the second image recognition model.

The user may switch an index used to calculate improvement degree and deterioration degree according to the purpose of accuracy comparison of the image recognition device or a value of improvement degree and deterioration degree actually calculated based on a certain index. That is, the evaluation device 12 may further include a receiving part that receives a change, made by the user, in a combination of the first inference index information generated based on the first image recognition model and a combination of the second inference index information generated based on the second image recognition model.

The receiving part may receive input, by the user, of an index to be evaluated, a class to be evaluated, and strictness of evaluation. The index to be evaluated indicates at least one of deterioration degree and improvement degree. The class to evaluate indicates at least one of a plurality of classes to be classified. The strictness of evaluation indicates any of “strict”, “normal”, and “lenient”. The strictness of evaluation can be designated for each of correctness and incorrectness.

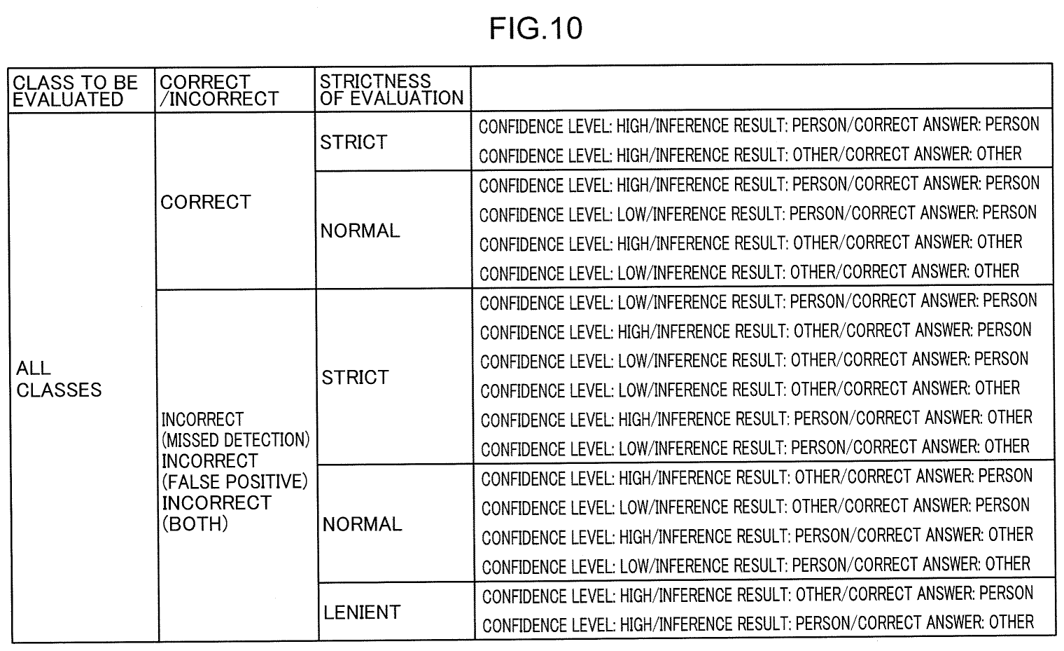

FIG. 10 is a diagram illustrating an example of labels of the first inference index information and the second inference index information associated with correctness or incorrectness and strictness of evaluation in a case where classes to be evaluated are all classes in the present embodiment. Note that there are three types of incorrectness, missed detection, false positive, and both, and the missed detection indicates an incorrect inference in which a detection target (for example, a person) is inferred as something other than a detection target (for example, other), and false positive indicates an incorrect inference in which something other than a detection target is inferred as a detection target. In a case where classes to be evaluated are all classes, a type of incorrectness is not designated.

In a case where an index to be evaluated is “deterioration degree”, a class to be evaluated is “all classes”, strictness of evaluation of correctness is “strict”, and strictness of evaluation of incorrectness is “normal”, “confidence level: high/inference result: person/correct answer: person” and “confidence level: high/inference result: other/correct answer: other” are selected as labels of the first inference index information, and “confidence level: high/inference result: other/correct answer: person”, “confidence level: low/inference result: other/correct answer: person”, “confidence level: high/inference result: person/correct answer: other”, and “confidence level: low/inference result: person/correct answer: other” are selected as labels of the second inference index information.

Furthermore, in a case where an index to be evaluated is “improvement degree”, a class to be evaluated is “all classes”, strictness of evaluation of correctness is “strict”, and strictness of evaluation of incorrectness is “normal”, “confidence level: high/inference result: other/correct answer: person”, “confidence level: low/inference result: other/correct answer: person”, “confidence level: high/inference result: person/correct answer: other”, and “confidence level: low/inference result: person/correct answer: other” are selected as labels of the first inference index information, and “confidence level: high/inference result: person/correct answer: person” and “confidence level: high/inference result: other/correct answer: other” are selected as labels of the second inference index information.

Furthermore, in a case where an index to be evaluated is “deterioration degree”, a class to be evaluated is “all classes”, strictness of evaluation of correctness is “strict”, and strictness of evaluation of incorrectness is “strict”, “confidence level: high/inference result: person/correct answer: person” and “confidence level: high/inference result: other/correct answer: other” are selected as labels of the first inference index information, and “confidence level: high/inference result: other/correct answer: person”, “confidence level: low/inference result: other/correct answer: person”, “confidence level: low/inference result: person/correct answer: person”, “confidence level: high/inference result: person/correct answer: other”, “confidence level: low/inference result: person/correct answer: other”, and “confidence level: low/inference result: other/correct answer: other” are selected as labels of the second inference index information.

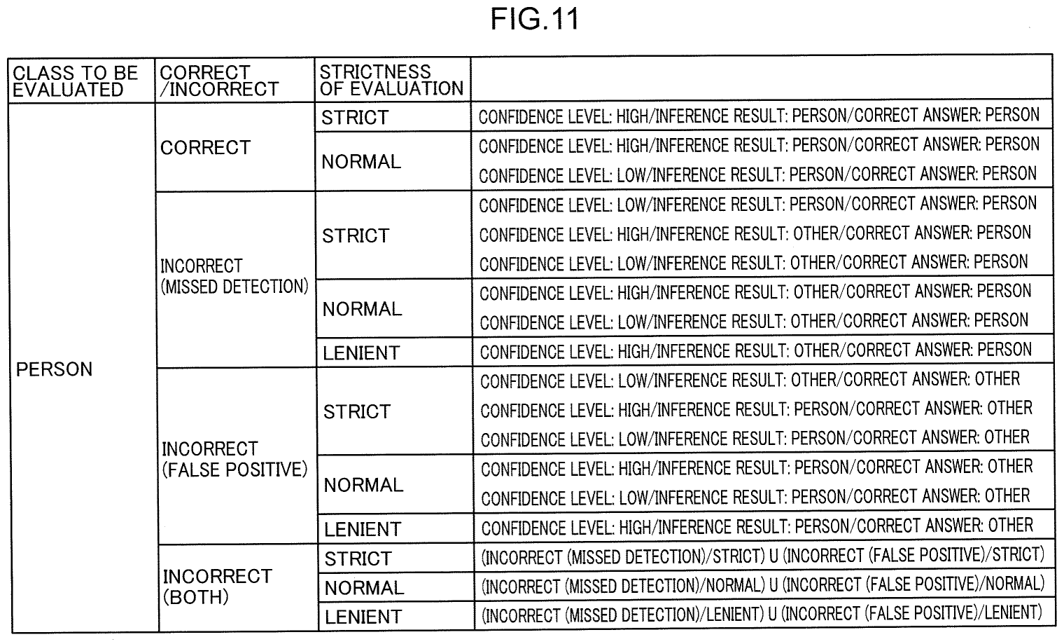

FIG. 11 is a diagram illustrating an example of labels of the first inference index information and the second inference index information associated with correctness or incorrectness and strictness of evaluation in a case where a class to be evaluated is a person in the present embodiment. In a case where a class to be evaluated is a detection target (for example, person), a type of incorrectness is designated.

In a case where an index to be evaluated is “deterioration degree”, a class to be evaluated is “person”, strictness of evaluation of correctness is “strict”, strictness of evaluation of incorrectness is “strict”, and a type of incorrectness is “missed detection”, “confidence level: high/inference result: person/correct answer: person” is selected as a label of the first inference index information, and “confidence level: low/inference result: person/correct answer: person”, “confidence level: high/inference result: other/correct answer: person”, and “confidence level: low/inference result: other/correct answer: person” are selected as labels of the second inference index information.

As described above, in comparison evaluation between the first image recognition device 10 and the second image recognition device 11 according to the present embodiment, it is possible to accurately compare inference accuracy of the first image recognition device 10 with inference accuracy of the second image recognition device 11 by considering the uncertainty (confidence level) of an inference result. Further, in a case where the first image recognition device 10 and the second image recognition device 11 perform semantic segmentation, since inference results are compared in units of pixels, it is possible to perform comparison in which a local change in inference is captured.

### (First Variation)

In the present embodiment, an evaluation method for performing classification and aggregation on a per-pixel basis in a case where the first image recognition model and the second image recognition model perform semantic segmentation is described, but the present disclosure is not particularly limited to this. The evaluation method of the present disclosure may perform classification and aggregation on a per-image basis in a case where the first image recognition model and the second image recognition model perform classification. Further, the evaluation method of the present disclosure may perform classification and aggregation on a per-bounding-box basis in a case where the first image recognition model and the second image recognition model perform object detection.

### (Second Variation)

In the present embodiment, inference accuracy of two image recognition models (image recognition devices) is compared, but the present disclosure is not particularly limited to this, and inference accuracy of one image recognition model (image recognition device) may be evaluated. Performance of the first image recognition model (first image recognition device 10) alone can be evaluated as the first inference index information is aggregated with respect to a plurality of evaluation target images in a test data set prepared in advance.

The acquisition part 121 may acquire an inference result of an evaluation target image by the first image recognition model generated by machine learning, and uncertainty information indicating instability degree of the inference result. The generation part 122 may use a correct answer label, an inference result, and uncertainty information associated with an evaluation target image to generate first inference index information in which a confidence level indicating reliability of the inference result is assigned to information indicating whether the inference result is correct or incorrect. The evaluation part 123 may evaluate inference accuracy of the first image recognition model based on the first inference index information. The output part 124 may output an evaluation result by the evaluation part 123.

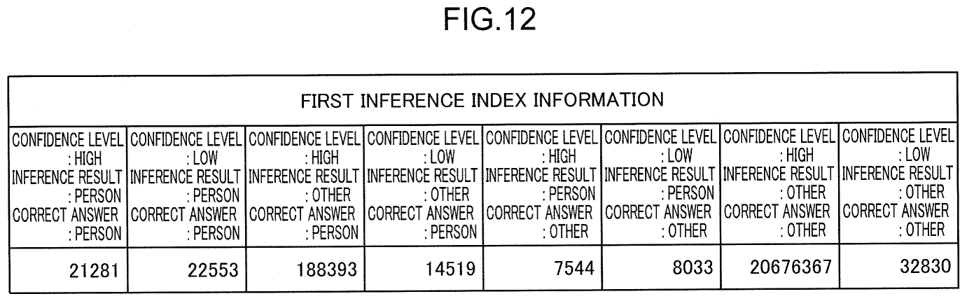

FIG. 12 is a diagram illustrating an example of a result of aggregating the number of pixels of each label included in the first inference index information with respect to a plurality of evaluation target images in a second variation of the present embodiment.

In FIG. 12, the first image recognition model performs semantic segmentation for detecting a pixel representing a person from an evaluation target image. Further, the example of FIG. 12 illustrates an aggregation result using the first inference index information generated from ten evaluation target images.

In the example of FIG. 12, the total number of pixels of a plurality of evaluation target images in a test data set is, from the product of the number of (ten) evaluation target images and a resolution (2048*1024) of the evaluation target images, 10*2048*1024=20971520.

As performance evaluation of the first image recognition device 10, for example, in a case where inference accuracy is strictly evaluated using only a correct answer label with a high confidence level, the evaluation part 123 may calculate an evaluation index value by adding the number of pixels of each of labels “confidence level: high/inference result: person/correct answer: person” and “confidence level: high/inference result: other/correct answer: other” of the first inference index information and dividing the added value by the total number of pixels. In this case, the evaluation index value is calculated as (21281+20676367)/20971520*100=98.69(%). Note that evaluation of inference accuracy of an image recognition model (image recognition device) may be calculated based on another index.

As described above, since inference accuracy of the first image recognition model is evaluated in consideration of a confidence level indicating how reliable an inference result is, it is possible to distinguish and evaluate an inference result that is accidentally correct and an inference result that is correct with high confidence, and it is possible to more accurately evaluate inference accuracy of the first image recognition model.

### (Third Variation)

In the present embodiment, the evaluation device 12 may have a function of the first image recognition device 10 and the second image recognition device 11. That is, the evaluation device 12 may include the acquisition part 101, the inference part 102, and the storage part 103 of the first image recognition device 10, and may include the acquisition part 111, the inference part 112, and the storage part 113 of the second image recognition device 11.

Note that in each of the above embodiments, each constituent element may be realized by being configured with dedicated hardware or by execution of a software program suitable for each constituent element. Each constituent element may be realized by a program execution part, such as a CPU or a processor, reading and executing a software program recorded in a recording medium such as a hard disk or a semiconductor memory.

Some or all functions of the devices according to the embodiment of the present disclosure are realized as Large Scale Integration (LSI), which is typically an integrated circuit. These may be individually integrated into one chip, or may be integrated into one chip so as to include some or all of these. Further, circuit integration is not limited to LSI, and may be realized by a dedicated circuit or a general-purpose processor. A Field Programmable Gate Array (FPGA), which can be programmed after manufacturing of LSI, or a reconfigurable processor in which connection and setting of circuit cells inside LSI can be reconfigured may be used.

Further, some or all functions of the device according to the embodiment of the present disclosure may be realized by a processor such as a CPU executing a program.

Further, the numerical figures used above are all illustrated to specifically describe the present disclosure, and the present disclosure is not limited to the illustrated numerical figures.

Further, order in which steps illustrated in the above flowchart are executed is exemplified for specifically describing the present disclosure, and may be any order other than the above order as long as a similar effect is obtained. Further, some of the above steps may be executed simultaneously (in parallel) with other steps.

Since the technique according to the present disclosure can more accurately evaluate inference accuracy of an image recognition model, it is useful as a technique for evaluating inference accuracy of the image recognition model.

1. An information processing method executed by a computer, the information processing method comprising:
acquiring an inference result of an evaluation target image by an image recognition model generated by machine learning and uncertainty information indicating instability degree of the inference result;
generating, by using a correct answer label associated with the evaluation target image, the inference result, and the uncertainty information, inference index information to which a confidence level indicating reliability of the inference result is assigned to information indicating whether the inference result is correct or incorrect; and
evaluating inference accuracy of the image recognition model based on the inference index information.

2. The information processing method according to claim 1, wherein the evaluation of the inference accuracy includes aggregating a plurality of pieces of inference index information acquired from a plurality of evaluation target images, and evaluating the inference accuracy of the image recognition model based on a result of the aggregation.

3. The information processing method according to claim 1, wherein the generation of the inference index information includes generating the inference index information in which the correct answer label, a class recognized as the inference result by the image recognition model, and the confidence level of N stages are associated with an inference unit of the image recognition model.

4. The information processing method according to claim 3, wherein the confidence level of N stages includes a first confidence level and a second confidence level lower than the first confidence level.

5. The information processing method according to claim 3, wherein
the image recognition model includes a first image recognition model and a second image recognition model, and
the evaluation of the inference accuracy includes comparing the inference accuracy of the first image recognition model with the inference accuracy of the second image recognition model according to a change from first inference index information generated based on the first image recognition model to second inference index information generated based on the second image recognition model.

6. The information processing method according to claim 5, wherein the evaluation of the inference accuracy includes counting number of the inference units that change from the first inference index information in which the inference result is correct to the second inference index information in which the inference result is incorrect, and calculating deterioration degree indicating how much the inference accuracy of the second image recognition model is deteriorated with respect to the inference accuracy of the first image recognition model according to the counted number.

7. The information processing method according to claim 5, wherein
the evaluation of the inference accuracy includes:
counting number of the inference units that change from the first inference index information in which the confidence level is a first confidence level and the inference result is correct to the second inference index information in which the confidence level is a second confidence level lower than the first confidence level and the inference result is correct, and calculating the deterioration degree according to the counted number; or
counting number of the inference units that change from the first inference index information in which the confidence level is the second confidence level and the inference result is incorrect to the second inference index information in which the confidence level is the first confidence level and the inference result is incorrect, and calculating the deterioration degree according to the counted number.

8. The information processing method according to claim 5, wherein the evaluation of the inference accuracy includes counting number of the inference units that change from the first inference index information in which the inference result is incorrect to the second inference index information in which the inference result is correct, and calculating improvement degree indicating how much the inference accuracy of the second image recognition model is improved with respect to the inference accuracy of the first image recognition model according to the counted number.

9. The information processing method according to claim 5, wherein
the evaluation of the inference accuracy includes:
counting number of the inference units that change from the first inference index information in which the confidence level is a second confidence level lower than a first confidence level and the inference result is correct to the second inference index information in which the confidence level is the first confidence level and the inference result is correct, and calculating the improvement degree according to the counted number; or
counting number of the inference units that change from the first inference index information in which the confidence level is the first confidence level and the inference result is incorrect to the second inference index information in which the confidence level is the second confidence level and the inference result is incorrect, and calculating the improvement degree according to the counted number.

10. The information processing method according to claim 5, further comprising:
receiving a change of a combination of the first inference index information generated based on the first image recognition model and a combination of the second inference index information generated based on the second image recognition model.

11. The information processing method according to claim 1, wherein an inference unit of the image recognition model is for each pixel constituting the evaluation target image.

12. The information processing method according to claim 11, wherein the image recognition model performs semantic segmentation for classifying each of a plurality of pixels constituting the evaluation target image into one or more classes.

13. The information processing method according to claim 1, wherein an inference unit of the image recognition model is for each of the evaluation target images.

14. The information processing method according to claim 13, wherein the image recognition model classifies the evaluation target image into one or more classes.

15. The information processing method according to claim 1, wherein the inference unit of the image recognition model is for each bounding box in the evaluation target image.

16. The information processing method according to claim 15, wherein the image recognition model detects a specific object included in the evaluation target image.

17. An information processing system comprising:
an acquisition part that acquires an inference result of an evaluation target image by an image recognition model generated by machine learning and uncertainty information indicating instability degree of the inference result;
a generation part that generates, by using a correct answer label associated with the evaluation target image, the inference result, and the uncertainty information, inference index information to which a confidence level indicating reliability of the inference result is assigned to information indicating whether the inference result is correct or incorrect; and
an evaluation part that evaluates inference accuracy of the image recognition model based on the inference index information.

18. A non-transitory computer readable recording medium storing an information processing program that causes a computer to function to:
acquire an inference result of an evaluation target image by an image recognition model generated by machine learning and uncertainty information indicating instability degree of the inference result;
generate, by using a correct answer label associated with the evaluation target image, the inference result, and the uncertainty information, inference index information to which a confidence level indicating reliability of the inference result is assigned to information indicating whether the inference result is correct or incorrect; and
evaluate inference accuracy of the image recognition model based on the inference index information.
